(19) United States
(12) Patent Application Publication
(10) Pub. No.: US 2011/0112002 A1
(43) Pub. Date: May 12, 2011

(54) METHODS OF CLEANING COMPONENTS HAVING INTERNAL PASSAGES

(75) Inventors: Timothy Hudson, Greenville, SC (US); William F. Hehmann, Spartanburg, SC (US); Rajiv Ratna Singh, Getzville, NY (US); Phil Roark, Simpsonville, SC (US); Ryan Hulse, Getzville, NY (US); Andrew Poss, Kenmore, NY (US)

(73) Assignee: HONEYWELL INTERNATIONAL INC., Morristown, NJ (US)

(21) Appl. No.: 12/617,479

(22) Filed: Nov. 12, 2009

(51) Int. Cl. C11D 1/02

(52) U.S. Cl. 510/186

(57) ABSTRACT

Methods are provided for cleaning a component having internal passages. A method includes contacting the component with an aqueous hydrogen fluoride solution without agitating the solution for a time period in a range of about 20 minutes to about an hour to dissolve a solid piece of blockage material blocking at least a portion of the internal passages, the aqueous hydrogen fluoride solution comprising, by volume, about 40 percent to about 60 percent hydrogen fluoride and optionally, a corrosion inhibitor, and the blockage material comprising a silicate and rinsing the component with water to remove at least a portion of the aqueous hydrogen fluoride solution from surfaces of the component defining at least a portion of the internal passages.

### TECHNICAL FIELD

The inventive subject matter generally relates to engines, and more particularly relates to methods of cleaning components of engines, where the components have internal passages.

### BACKGROUND

Gas turbine engines may be used to power various types of vehicles and systems, such as, for example, helicopters or other aircraft. Typically, these engines include turbine blades (or airfoils) that are impinged upon by high-energy compressed air that causes a turbine of the engine to rotate at a high speed. Consequently, the blades are subjected to high heat and stress loadings which, over time, may reduce their structural integrity.

To enhance the useful life of the aforementioned blades, modern gas turbine engines have employed internal cooling systems in the blades to maintain blade wall temperatures within acceptable limits. Typically, the blades are air cooled using, for example, bleed air from a compressor section of the engine. Specifically, air enters near the blade root and flows through one or more cooling circuits formed in the turbine blade. The one or more cooling circuits may consist of a series of connected internal passages that form serpentine paths, which together extend the length of the air flow path to thereby increase the cooling effectiveness of the cooling circuits.

Although the aforementioned blades are intended for use in a variety of environments, when the blades are included in engines that operate in environments having an increased amount of fine sand or silt particles (e.g., particles having average diameters in a range of about 0.004 millimeters (mm) to about 0.50 mm), such as in a desert environment, the particles may be routed with the airflow through the internal passages in the turbine blades. Over time, the particles may accumulate in the internal passages. In some cases, the particles melt to form an unwanted brittle, amorphous glass-like material that blocks the cooling air flow and covers the surfaces of the blades. Because the unwanted material is difficult to remove, and the components within which the unwanted material accumulation typically are discarded.

Accordingly, it is desirable to have a method of removing the unwanted material from the internal passages of components. In addition, it is desirable for the method to be relatively simple and inexpensive to perform. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Methods are provided for cleaning a component having internal passages.

In an embodiment, by way of example only, a method includes contacting the component with an aqueous hydrogen fluoride solution without agitating the solution for a time period in a range of about 20 minutes to about an hour to dissolve a solid piece of blockage material blocking at least a portion of the internal passages, the aqueous hydrogen fluoride solution comprising, by volume, about 40 percent to about 60 percent hydrogen fluoride and optionally, a corrosion inhibitor, and the blockage material comprising a silicate and rinsing the component with water to remove at least a portion of the aqueous hydrogen fluoride solution from surfaces of the component defining at least a portion of the internal passages.

In another embodiment, by way of example only, a method includes submerging the component into a container including aqueous hydrogen fluoride solution without agitation of the solution for a time period in a range of about 20 minutes to about an hour to dissolve a solid piece of blockage material blocking at least a portion of the internal passages, the aqueous hydrogen fluoride solution comprising, by volume, about 40 percent to about 60 percent hydrogen fluoride and optionally, a corrosion inhibitor, and the blockage material comprising silicon dioxide, exposing the component to a neutralizing solution, and subjecting the component additional rinsing to remove at least a portion of the neutralizing solution from the component.

### BRIEF DESCRIPTION OF THE DRAWINGS

The inventive subject matter will hereinafter be described in conjunction with the following drawing figures, wherein like numerals denote like elements, and

FIG. 1 is a perspective pressure (concave) side view of a blade, according to an embodiment;

FIG. 2 is a perspective suction (convex) side view of the blade of FIG. 1, according to an embodiment;

FIG. 3 is a perspective view of the blade of FIG. 1 showing blade cooling circuits in phantom, according to an embodiment;

FIG. 4 is an enlarged cutaway perspective view of the blade of FIG. 3, where the view is similar in direction to that of FIG. 1, according to an embodiment; and

FIG. 5 is a flow diagram of a method of cleaning a component having internal passages, according to an embodiment.

### DETAILED DESCRIPTION

The following detailed description is merely exemplary in nature and is not intended to limit the inventive subject matter or the application and uses of the inventive subject matter. Although the inventive subject matter is described as being performed on aircraft components, other components having internal passages within which unwanted material may be disposed alternatively may be employed. Furthermore, there is no intention to be bound by any theory presented in the preceding background or the following detailed description.

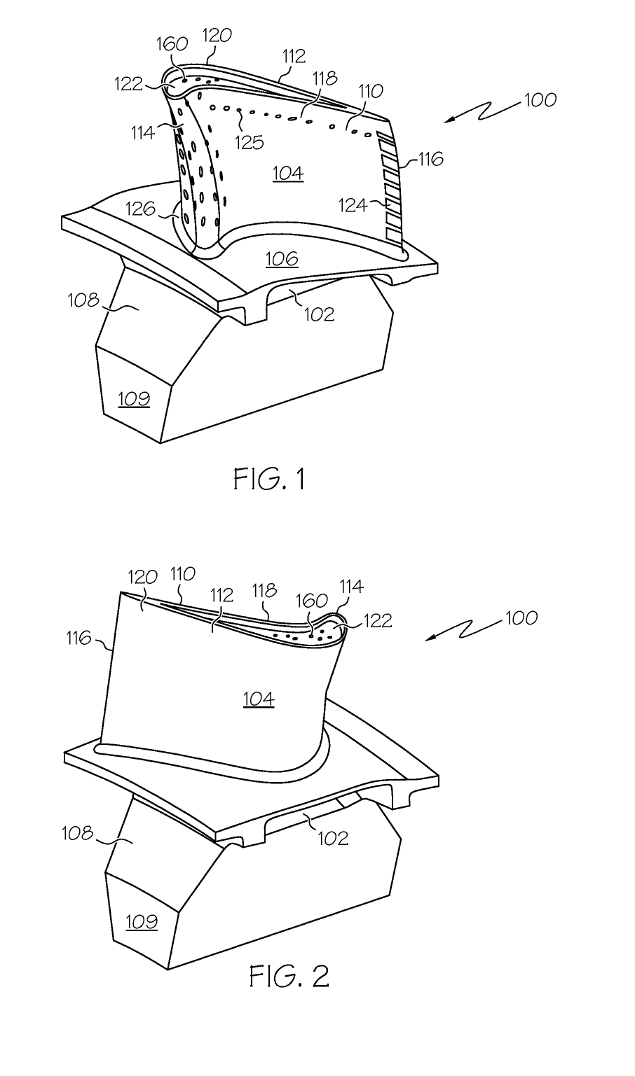

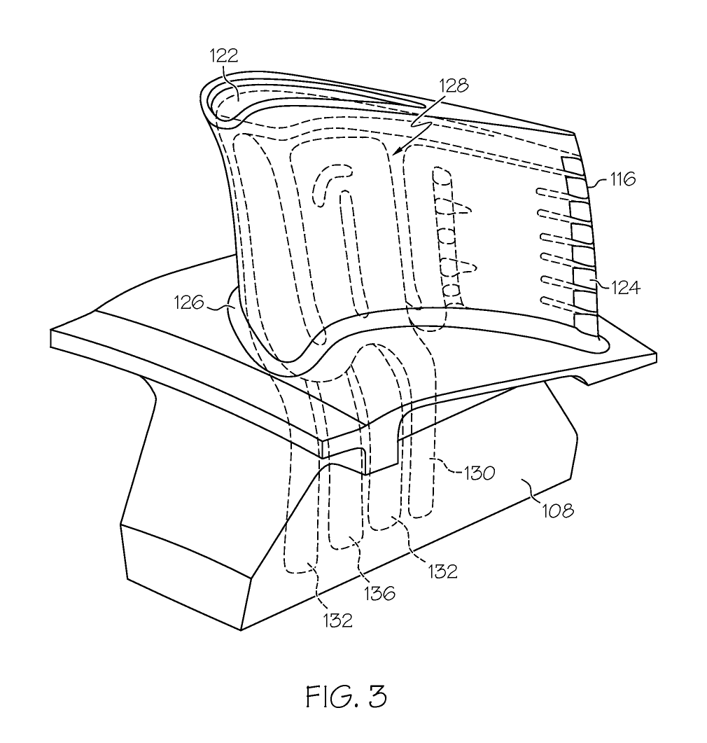

FIG. 1 is a perspective pressure (concave) side view of a blade, and FIG. 2 is a perspective suction (convex) side view of the blade of FIG. 1, according to an embodiment. The blade 100 includes a shank 102, an airfoil 104, a platform 106 and a root 108. The platform 106 is configured to radially contain turbine airflow. The root 108 provides an area in which a firtree 109 is machined. The firtree 109 is used to attach the blade 100 to a turbine rotor disc (not illustrated), in an embodiment. In other embodiments, instead of having a firtree shape, the root 108 may include a different shape suitable for attaching the blade 100 to the turbine disc. The airfoil 104 has a concave outer wall 110 and a convex outer wall 112, each having outer surfaces that together define an airfoil shape. The airfoil shape includes a leading edge 114, a trailing edge 116, a pressure side 118 along the first outer wall 110, a suction side 120 along the second outer wall 112, a blade tip 122, one or more trailing edge slots 124, cooling holes 125, 160, and an airfoil platform fillet 126. According to an embodiment, the blade 100 may include an internal cooling circuit 128 (shown in FIGS. 3-5) for cooling the pressure side wall 110, suction side wall 112, and tip 122 by directing air from an inlet formed in the root 108 to the trailing edge slots 124 and/or cooling holes 125 and 160.

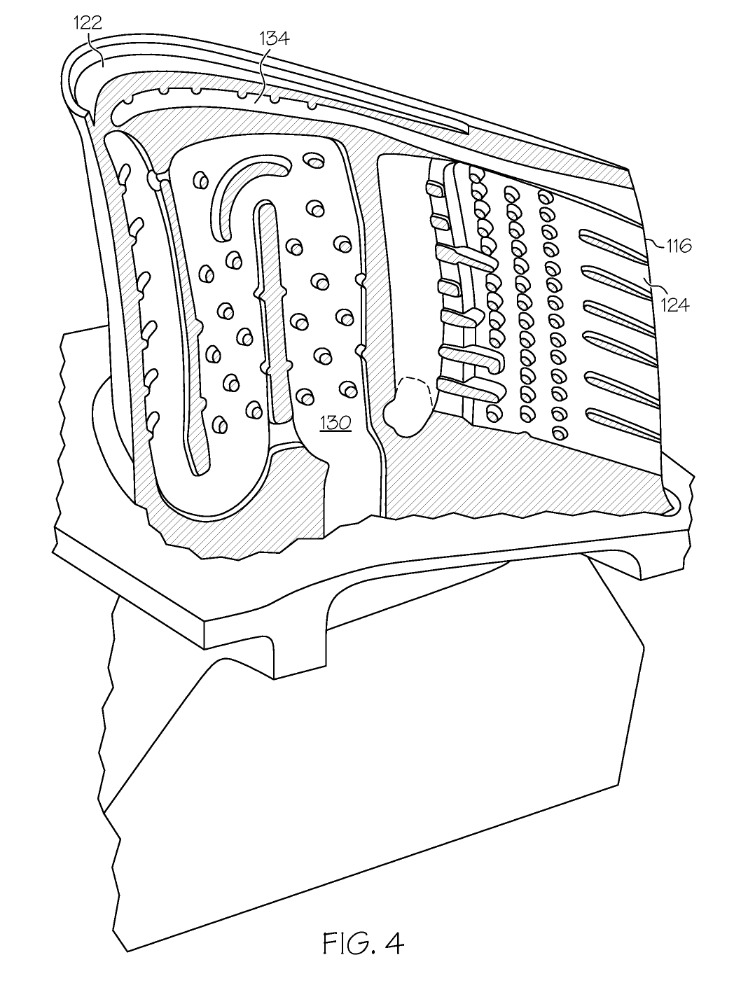

FIGS. 3 and 4 are perspective views of the blade 100 showing the internal cooling circuit 128, according to an embodiment. The internal cooling circuit 128 comprises a plurality of flow circuits and includes a pressure side flow circuit 130, a suction side flow circuit 132, a tip flow circuit 134, and a center flow circuit 136. The pressure side flow circuit 130 directs air from the root 108 along the pressure side wall 110. The suction side flow circuit 132 receives air from the root 108 and directs the air along the suction side wall 112. The tip flow circuit 134 receives air from a portion of the suction side flow circuit 132 and the center flow circuit 136 and directs the air along the tip 122. The center flow circuit 136 takes air from the root 108 and cools internal walls that also define portions of the other flow circuits 130, 132, 134.

As illustrated in FIGS. 3 and 4, the flow circuits (e.g., pressure side flow circuit 130 and suction side flow circuit 132) may define complex, serpentine flowpaths, which may potentially trap sand particles entrained in the air flowing through the passages of the internal cooling circuit 128. If exposed to elevated temperatures, the sand or silt particles, which may comprise a silicate, such as silicon dioxide (SiO₂), having particles sizes in a range of about 0.004 mm to about 0.50 mm, may form a solid piece of blockage material. The blockage material may be a brittle and amorphous glass-like piece of material. In such case, the blockage material may need to be removed.

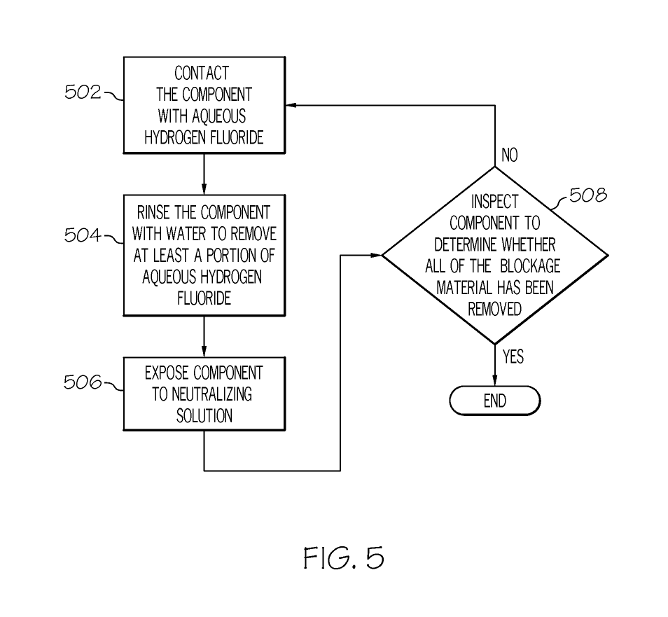

FIG. 5 is a flow diagram of a method 500 for cleaning a component having internal passages, according to an embodiment. The internal passages may be cooling passages as described above for the blade 100 (FIGS. 1-4) or may be any other internal passages of a different component. In an embodiment, the component is contacted with aqueous hydrogen fluoride solution, step 502. According to an embodiment, contact may occur by submerging the component into a container including aqueous hydrogen fluoride solution. The container may be a tank having walls that comprise material that may be resistant to degradation when contacted with hydrogen fluoride. For example, the material may comprise polypropylene, stainless steel or the like. In an embodiment, the container may be sized to accommodate a single component or multiple components. Thus, particular dimensions of the container may be selected based on the particular size and total number of the component to be treated. According to an embodiment, the component may be completely submerged in the aqueous hydrogen fluoride solution. In another embodiment, initially, a first portion of the component may be partially submerged. Subsequently, the component may be re-positioned using tooling, and a second portion (e.g., a remainder) of the component may be submerged in the aqueous hydrogen fluoride solution. In another embodiment, contacting the component with aqueous hydrogen fluoride solution may be performed by showering, by spraying, or another manner.

The aqueous hydrogen fluoride solution may include hydrogen fluoride and water, in an embodiment. In accordance with an embodiment, the aqueous hydrogen fluoride solution comprises up to about 49% by volume hydrogen fluoride and a remainder of water. In another embodiment, the aqueous hydrogen fluoride solution comprises, by volume, about 40% to about 60% hydrogen fluoride, and a remainder of water. According to another embodiment, the aqueous hydrogen fluoride solution may include a corrosion inhibitor. In an embodiment, the aqueous hydrogen fluoride solution may include a concentration of the corrosion inhibitor in a range of about 100 parts per million to about 50,000 parts per million. In another embodiment, the concentration of the corrosion inhibitor may be about 10,000 parts per million. In still another embodiment, the concentration of the corrosion inhibitor may be more or less than the aforementioned range. Suitable corrosion inhibitors include, but are not limited to aliphatic nitrogen compounds, such as amines and thiourea, benzoic acid and other oxygenated compounds and derivatives thereof, such as benzotriozole, and ionic compound, including sodium citrate and Rochelle salts. The aqueous hydrogen fluoride solution may be maintained at a temperature in a range of about 5° C. to about 100° C. to enhance erosion of the blockage material. In another embodiment, the temperature may be greater or less than the aforementioned range. In still another embodiment, the aqueous hydrogen fluoride may be pressurized.

During initial contact with the component, the aqueous hydrogen fluoride solution may be encouraged to flow into the internal passage. In an embodiment, the aqueous hydrogen fluoride solution may be injected into the internal passage of the component. According to another embodiment, a portion of the aqueous hydrogen fluoride solution may be fed into a suitably configured syringe or similar device, and a tip of the syringe may be inserted into an opening leading into the internal passage, while the component is also submerged in the aqueous hydrogen fluoride solution. Repeated injections may be performed on the component to thereby erode at least a portion of the blockage material in the internal passage of the component.

After injection into the internal passage, agitation within the aqueous hydrogen fluoride solution is removed. Thus, agitation does not occur while the component remains in the solution. The component may be contacted with the aqueous hydrogen fluoride solution for a time period that is sufficient to remove substantially all of the blockage material from the internal passage of the component. In an embodiment, submersion may occur for a time period in a range of about 20 minutes to about 1 hour. In other embodiments, the component may be submerged for a longer or shorter period of time, depending on the temperature of the aqueous hydrogen fluoride solution, and/or the amount of blockage material, and/or the complexity of the shapes of the internal passages to be cleaned. After contact, the component may be removed from the container or solution contact area and placed in another location, in an embodiment. In another embodiment, the aqueous hydrogen fluoride solution may be drained from the container.

In any case, the component is rinsed with water to remove at least a portion of the aqueous hydrogen fluoride solution from surfaces of the component, step 504. In an embodiment, rinsing may occur at the location employed for step 502, or the component may be removed from the location and placed in a separate rinsing area. For example, the rinsing area may include a separate container for receiving the component and the water. Rinsing may be performed by submerging the component in water, by employing a shower-like device to shower water over the component, by injecting water into the internal passages of the component or by another rinsing method. In an embodiment, the water may have a temperature in a range of about 5° C. to about 50° C., and the component may be rinsed for a period of about 30 seconds to about 10 minutes. In another embodiment, the water may be hotter or colder than the aforementioned range and/or rinsing may occur for a longer or shorter time period than that previously mentioned. According to an embodiment, the water may comprise deionized water, lake, river or city water or another type of water. After rinsing, the component may be removed from the location or rinsing area and placed in another location, in an embodiment. In another embodiment, the water may be drained from the container or rinsing area.

After the component is rinsed with water, the component is exposed to a neutralizing solution, step 506. The neutralizing solution may comprise sodium hydroxide, potassium hydroxide, sodium carbonate, sodium bicarbonate, potassium carbonate, potassium bicarbonate, calcium hydroxide, calcium carbonate or another solution suitable for neutralizing hydrogen fluoride. In accordance with an embodiment, the neutralizing solution may further include a corrosion inhibitor, such as aliphatic nitrogen compounds, such as amines and thiourea, benzoic acid and other oxygenated compounds and derivatives thereof, such as benzotriozole, and ionic compound, including sodium citrate and Rochelle salts. Exposure to the neutralizing solution may occur at the location employed during rinsing step 604 or may be performed in a separate neutralizing area. For example, the neutralizing area may include a separate container for receiving the component and the neutralizing solution. In any case, exposure may be performed by submerging the component in the neutralizing solution, by employing a shower-like device to shower the neutralizing solution over the component, by injecting the neutralizing solution into the internal passages of the component or by another method of exposure. In an embodiment, the neutralizing solution may have a temperature in a range of about 5° C. to about 50° C., and the component may be exposed to the neutralizing solution for a period of about 30 seconds to about 6 hours. In other embodiments, the temperature and/or exposure period may be greater or less than the aforementioned ranges. To remove the neutralizing solution from the component, the component may be subjected to additional water rinse steps, performed in a manner similar to step 504.

Next, the component may be inspected to determine whether the blockage material has been removed from the internal passages, step 508. In an embodiment, the component may be inspected using a waterflow. For example, the waterflow is injected into the internal passages under pressure and each internal passage is examined visually for adequate outflow of water. Visual and photograph standards are used as acceptance standards compared to the actual flow pattern. In another embodiment, the component is visually inspected. According to an embodiment, the component may be examined with an x-ray device, which may show whether blockage material remains within the internal passages. If a determination is made that the blockage material remains within the internal passages, the method 500 may be repeated, step 510. If a determination is made that the blockage material has been sufficiently removed from the internal passages, the component may be prepared for reintroduction into an engine.

A method is now provided for removing blockage material from the internal passages of components. The above-described method is capable of removing blockage material from internal passages of any shape, no matter the complexity. In addition, the method is relatively simple and inexpensive to perform. By cleaning the components, rather than discarding the component, engines including such components may be less expensive to maintain and operate.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of cleaning a component having internal passages, the method comprising the steps of:
contacting the component with an aqueous hydrogen fluoride solution without agitating the solution for a time period in a range of about 20 minutes to about an hour to dissolve a solid piece of blockage material blocking at least a portion of the internal passages, the aqueous hydrogen fluoride solution comprising, by volume, about 40 percent to about 60 percent hydrogen fluoride and optionally, a corrosion inhibitor, and the blockage material comprising a silicate; and
rinsing the component with water to remove at least a portion of the aqueous hydrogen fluoride solution from surfaces of the component defining at least a portion of the internal passages.

2. The method of claim 1, wherein the aqueous hydrogen fluoride solution comprises, by volume, up to about 49 percent hydrogen fluoride.

3. The method of claim 1, further comprising the step of exposing the component to a neutralizing solution, after the step of rinsing.

4. The method of claim 1, wherein the neutralizing solution comprises sodium hydroxide.

5. The method of claim 1, further comprising the step of injecting the aqueous hydrogen fluoride solution into a portion of the internal passages of the component.

6. The method of claim 1, wherein the corrosion inhibitor is selected from a group consisting of an aliphatic nitrogen compounds, benzoic acid and oxygenated compounds and derivatives thereof, and ionic compounds.

7. The method of claim 1, wherein the step of contacting includes exposing the component to the aqueous hydrogen fluoride solution for about an hour.

8. The method of claim 1, wherein the step of contacting includes submerging the component in a container including the aqueous hydrogen fluoride solution.

9. The method of claim 1, further comprising inspecting the component using a waterflow to determine whether the blockage material has been removed from the internal passages.

10. The method of claim 1, wherein the internal passages comprise one or more internal passages having a serpentine shape.

11. A method of cleaning a component having internal passages, the method comprising the steps of:
submerging the component into a container including aqueous hydrogen fluoride solution without agitation of the solution for a time period in a range of about 20 minutes to about an hour to dissolve a solid piece of blockage material blocking at least a portion of the internal passages, the aqueous hydrogen fluoride solution comprising, by volume, about 40 percent to about 60 percent hydrogen fluoride and optionally, a corrosion inhibitor, and the blockage material comprising silicon dioxide;
rinsing the component with water to remove at least a portion of the aqueous hydrogen fluoride solution from surfaces of the component defining at least a portion of the internal passages;
exposing the component to a neutralizing solution; and
subjecting the component additional rinsing to remove at least a portion of the neutralizing solution from the component.

12. The method of claim 11, wherein the aqueous hydrogen fluoride solution further comprises, by volume, up to about 49 percent hydrogen fluoride.

13. The method of claim 11, wherein the neutralizing solution comprises sodium hydroxide.

14. The method of claim 11, further comprising the step of injecting the aqueous hydrogen fluoride solution into a portion of the internal passages of the component.

15. The method of claim 11, further comprising wherein the corrosion inhibitor is selected from a group consisting of an aliphatic nitrogen compounds, benzoic acid and oxygenated compounds and derivatives thereof, and ionic compounds.

16. The method of claim 11, wherein the step of submerging includes exposing the component to the aqueous hydrogen fluoride solution for about an hour.

17. The method of claim 11, further comprising inspecting the component using a waterflow to determine whether the blockage material has been removed from the internal passages.

18. The method of claim 11, wherein the internal passages comprise one or more internal passages having a serpentine shape.
